(19) United States
(12) Patent Application Publication
(10) Pub. No.: US 2019/0258313 A1
(43) Pub. Date: Aug. 22, 2019

(54) SYSTEMS AND METHODS FOR INTERACTION WITH AN APPLICATION

(71) Applicant: CHANGCHUN RUIXINBOGUAN TECHNOLOGY DEVELOPMENT CO., LTD., Changchun (CN)

(72) Inventor: Shufen SUN, Changchun (CN)

(73) Assignee: CHANGCHUN RUIXINBOGUAN TECHNOLOGY DEVELOPMENT CO., LTD., Changchun (CN)

(21) Appl. No.: 16/344,928

(22) PCT Filed: Nov. 6, 2017
(86) PCT No.: PCT/CN2017/109528

§ 371 Date: Apr. 25, 2019

(30) Foreign Application Priority Data
Dec. 30, 2016 (CN) 201611260023.1
Dec. 30, 2016 (CN) 201621483468.1
Nov. 7, 2017 (CN) 201621198680.3

(51) Int. Cl. G06F 3/01; G02B 27/01; G06T 19/00; G06K 9/00

(52) U.S. Cl. CPC G06F 3/011; G02B 27/017; G06T 19/006; G02B 2027/0138; G06K 9/00342; G02B 2027/014; G06K 9/00315

(57) ABSTRACT

The disclosure relates to a display device. The display device includes at least one storage medium including a set of instructions and at least one processor implementing a virtual character application and at least one of a second application or an operating system. The virtual character application is configured to communicate with the at least one of the second application or the operating system. The processor is configured to communicate with the at least one storage medium. When executing the set of instructions, the display device receives intention data indicative of an intention operation of a user. The display device also executes the virtual character application to execute the at least one of the second application or the operating system to perform the intention operation of the user based on the intention data. The display device also executes the virtual character application to display a virtual character on the display device. The characteristic of the virtual character is related to the intention operation of the user.

### CROSS-REFERENCE OF RELATED APPLICATIONS

This application claims priority of Chinese Patent Application No. 201621198680.3, filed on Nov. 7, 2016, Chinese Patent Application No. 201611260023.1, filed on Dec. 30, 2016 and Chinese Patent Application No. 201621483468.1, filed on Dec. 30, 2016, the contents of which are hereby incorporated by reference.

### TECHNICAL FIELD

The present disclosure generally relates to processing of data, and more particularly, relates to systems and methods for interaction with a user.

### BACKGROUND

Online applications including game applications, social applications, are important in people's daily life. However, interaction between users and the online applications are substantially limited in that to interact with online applications, a controller such as a mouse, a keyboard, or a hand shank, may be necessary. Thus, it may be desirable to provide systems and methods for providing a method and system for convenient interaction between users and applications.

### SUMMARY

In a first aspect of the present disclosure, a device for display is provided. The device may include at least one storage medium including a set of instructions, and at least one processor implementing a virtual character application and at least one of a second application or an operating system. The virtual character application may be configured to communicate with the at least one of the second application or the operating system. The at least one processor may be configured to communicate with the at least one storage medium. When executing the set of instructions, the device may be configured to receive intention data indicative of an intention operation of a user. The device may be configured to execute the virtual character application to execute the at least one of the second application or the operating system to perform the intention operation of the user based on the intention data. The device may be configured to execute the virtual character application to display a virtual character on the display device. A characteristic of the virtual character may be related to the intention operation of the user.

In some embodiments, the device may include a head-mounted display device.

In some embodiments, the head-mounted display device may include a mounting component, a display component mounted on the mounting component, an image receiver implemented on the mounting component, and an image processor. The image receiver may be configured to receive a facial image of the user. The image processor may be configured to process the facial image of the user to determine an expression of the user.

In some embodiments, the image receiver may be detachably mounted on the mounting component.

In some embodiments, the image receiver may include a communication plug, and the image processor may include a communication socket.

In some embodiments, the communication plug may be configured to plug into the communication socket to transmit the facial image of the user to the image processor.

In some embodiments, the mounting component may include a shell and an immobilizing component. The immobilizing component may be configured to immobilize the shell on the user's head.

In some embodiments, the shell may define a chamber. An end of the shell may include an opening connected to the chamber.

In some embodiments, the shell may include a side panel and a front panel. The image receiver may be mounted on the side panel.

In some embodiments, the image receiver may include an internal image receiver and an external image receiver. The external image receiver may be located on an external surface of the side panel.

In some embodiments, the display component may include a display screen configured on the front panel, and a lens component. The lens component may include a frame and a lens configured on the frame.

In some embodiments, the mounting component may include a bracket and a temple. The display component may include a projector.

In some embodiments, the image receiver may be configured on the bracket.

In some embodiments, the projector maybe configured on the mounting component to project the presentation result to an eye of the user.

In some embodiments, the image receiver may be configure to collect at least one of an image of the user's mouth, an image of the user's nose, an image of the user's facial muscles, an image of the user's eyes, an image of the user's eyebrows, an image of the user's eyelids, or an image of the user's glabella.

In some embodiments, the device may further include a data transmitter being located on the mounting component and being connected to the image processor. The data transmitter may be configured to communicate with an external device.

In some embodiments, the HMD device may further comprise a HMD-end wireless component configured to communicate with a host-end wireless component. The HMD-end wireless component may comprise a battery and a power management unit, a HMD-end data processing and controlling unit and a HMD-end antenna. The battery and the power management unit may be connected to the HMD device via a first cable or a first connector. The battery and the power management unit may be connected to the HMD-end data processing and controlling unit and the HMD-end antenna via a PCB Trace, a first internal cable or a first internal connector. The HMD-end data processing and controlling unit may be connected to the HMD device via the first cable or the first connector. The HMD-end data processing and controlling unit may be connected to the HMD-end antenna via the PCB Trace, the first internal cable or the first internal connector. The host-end wireless component may comprise a host-end data processing and controlling unit and a host-end antenna. The host-end data processing and controlling unit may be connected to a power via a second cable or a second connector. The host-end data processing and controlling unit may be connected to the host-end antenna via a PCB Trace, a second internal cable or a second internal connector. The host-end data processing and controlling unit may be connected to a host or a signal resource via the second cable or the second connector.

In some embodiments, the HMD device may be configured to transmit a signal to the host-end wireless component via the HMD-end wireless component.

In some embodiments, the signal may relate to a location of the HMD or a motion of the HMD.

In a second aspect of the present disclosure, a method is provided. The method may be implemented on a display device for displaying an image. The method may include one or more of the following operations. The method include receiving intention data indicative of an intention operation of a user by a processor implementing a virtual character application. The virtual character application may be configured to communicate with at least one of a second application or an operating system. The method may include executing the virtual character application to execute the at least one of the second application or the operating system to perform the intention operation of the user based on the intention data. The method may include executing the virtual character application to display a virtual character on the display device, wherein a characteristic of the virtual character is related to the intention operation of the user.

In some embodiments, the method may further include receiving user information related to the user. The method may further include generating the intention data at least based on the user information.

In some embodiments, the method may further include providing an execution result of the execution of the intention operation of the user through the virtual character on the display device.

In some embodiments, the characteristic of the virtual character may include at least one of an action of the virtual character, an operation of the virtual character, an expression of the virtual character, a voice of the virtual character, or an image of the virtual character.

In some embodiments, the method may further include determining whether a trigger condition is satisfied. The method may further include executing the virtual character application in response to a determination that a trigger condition is satisfied.

In some embodiments, the method may further include determining whether an interactive operation is performed by a user The method may further include executing the virtual character application in response to a determination that the interactive operation is performed by the user.

In some embodiments, the method may further include receiving historical operation data of the user

In some embodiments, the method may further include generating the intention data based on the user information and the historical operation data of the user.

In some embodiments, the method may further include receiving a first set of recommendation data. The method may further include selecting a second set of recommendation data from the first set of recommendation data based on the historical operation data of the user.

In some embodiments, the method may further include generating the intention data based on the user information and the second set of recommendation data.

In some embodiments, the virtual character may include at least one of a virtual person, a virtual humanoid, a virtual human face, or a virtual creature.

In some embodiments, the user information may include an expression of the user, an action of the user, a voice of the user, and information input by the user.

In some embodiments, the method may further include generating the intention data by analyzing the expression of the user, the action of the user, the voice of the user, and the information input by the user.

In some embodiments, the user information may further include an expression of the user.

In some embodiments, the method may further include receiving a facial image of the user by at least one sensor implemented on the display device. The method may further include processing the facial image of the user to determine the expression of the user.

In a third aspect of the present disclosure, a non-transitory computer readable medium including at least one set of instructions may be provided. The at least one set of instructions may be executed by at least one processor of a computing device. The at least one processor may be configured to receive intention data indicative of an intention operation of a user. The at least one processor may be configured to implement the virtual character application and the at least one of the second application or the operating system, execute the virtual character application to execute the at least one of the second application or the operating system to perform the intention operation of the user based on the intention data. The at least one processor may be configured to execute the virtual character application to display a virtual character on the display device. A characteristic of the virtual character may be related to the intention operation of the user.

In a fourth aspect of the present disclosure, a system may be provided. The system may include a collecting module, an analyzing module, a processing module, and an executing module. The collecting module may be configured to collect user information. The analyzing module may be configured to analyze the user information to generate at least one analyzing result. The processing module may be configured to process the at least one analyzing result to determine an intention operation of the user, wherein the processing module is implemented by a virtual character application and at least one of a second application or an operating system, the virtual character application being configured to communicate with the at least one of the second application or the operating system. The executing module may be configured to execute the virtual character application to execute the at least one of the second application or the operating system to perform the intention operation of the user based on the intention data, and display a virtual character on a display device of the system, wherein a characteristic of the virtual character is related to the intention operation of the user.

In a fifth aspect of the present disclosure, a head-mounted display (HMD) device comprising a HMD-end wireless component is provided. The HMD-end wireless component may be configured to communicate with a host-end wireless component. The HMD-end wireless component may comprise a battery and a power management unit, a HMD-end data processing and controlling unit and a HMD-end antenna. The battery and the power management unit may be connected to the HMD device via a first cable or a first connector. The battery and the power management unit may be connected to the HMD-end data processing and controlling unit and the HMD-end antenna via a PCB Trace, a first internal cable or a first internal connector. The HMD-end data processing and controlling unit may be connected to the HMD device via the first cable or the first connector. The HMD-end data processing and controlling unit may be connected to the HMD-end antenna via the PCB Trace, the first internal cable or the first internal connector. The host-end wireless component may comprise a host-end data processing and controlling unit and a host-end antenna. The host-end data processing and controlling unit may be connected to a power via a second cable or a second connector. The host-end data processing and controlling unit may be connected to the host-end antenna via a PCB Trace, a second internal cable or a second internal connector. The host-end data processing and controlling unit may be connected to a host or a signal resource via the second cable or the second connector.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagrams illustrating an exemplary interaction system according to some embodiments of the present disclosure;

FIG. 2 is a schematic diagram illustrating an exemplary computing device on which the medical imaging system can be implemented, according to some embodiments of the present disclosure;

FIG. 3 is a schematic diagram illustrating exemplary hardware and/or software components of an exemplary mobile device on which the terminal may be implemented according to some embodiments of the present disclosure;

FIG. 4 is a block diagram illustrating an exemplary head-mounted display device according to some embodiments of the present disclosure;

FIG. 5 is a flowchart illustrating an exemplary process for interaction with an application according to some embodiments of the present disclosure;

FIG. 6 is a block diagram illustrating an exemplary processor according to some embodiments of the present disclosure;

FIG. 7 is a flowchart illustrating an exemplary process for interaction with an application according to some embodiments of the present disclosure;

FIG. 8 is a block diagram illustrating an exemplary processor according to some embodiments of the present disclosure;

FIG. 9 is a block diagram illustrating an exemplary processor according to some embodiments of the present disclosure;

FIG. 10 is a block diagram illustrating an exemplary processor according to some embodiments of the present disclosure;

FIG. 11 is a block diagram illustrating an exemplary executing module according to some embodiments of the present disclosure;

FIG. 12 is a block diagram illustrating an exemplary collecting module according to some embodiments of the present disclosure;

FIG. 13A is a schematic diagram illustrating an exemplary head-mounted display device according to some embodiments of the present disclosure;

FIG. 13B is a schematic diagram illustrating cross-sectional views illustrating a head-mounted display device according to some embodiments of the present disclosure;

FIG. 14 is a schematic diagram illustrating an exemplary head-mounted display device according to some embodiments of the present disclosure;

FIG. 15 is a schematic diagram illustrating an exemplary head-mounted display device according to some embodiments of the present disclosure;

FIG. 16 is a schematic diagram illustrating an exemplary processing engine according to some embodiments of the present disclosure;

FIG. 17 is a schematic diagram illustrating an exemplary interaction system in prior art; and

FIG. 18 is a schematic diagram illustrating an exemplary interaction system according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including”, when used in this specification, specify the presence of stated features, integers, steps, operations, elements, and/or components, but do not preclude the presence or addition of one or more other features, integers, steps, operations, elements, components, and/or groups thereof.

It will be understood that the term “system,” “engine,” “unit,” and/or “module” used herein are one method to distinguish different components, elements, parts, section or assembly of different level in ascending order. However, the terms may be displaced by another expression if they achieve the same purpose.

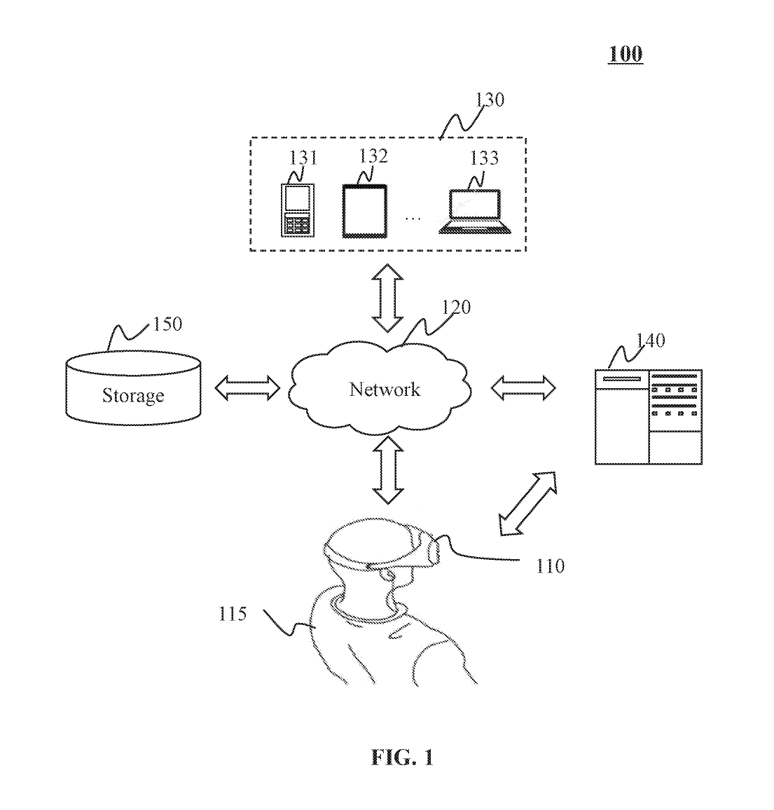

Generally, the word “module” or “unit” as used herein, refers to logic embodied in hardware or firmware, or to a collection of software instructions. A module or a unit described herein may be implemented as software and/or hardware and may be stored in any type of non-transitory computer-readable medium or another storage device. In some embodiments, a software module/unit may be compiled and linked into an executable program. It will be appreciated that software modules can be callable from other modules/units or themselves, and/or may be invoked in response to detected events or interrupts. Software modules/units configured for execution on computing devices (e.g., processing engine 140 as illustrated in FIG. 1) may be provided on a computer-readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules/units may be included in connected logic components, such as gates and flip-flops, and/or can be included of programmable units, such as programmable gate arrays or processors. The modules/units or computing device functionality described herein may be implemented as software modules/units but may be represented in hardware or firmware. In general, the modules/units described herein refer to logical modules/units that may be combined with other modules/units or divided into sub-modules/sub-units despite their physical organization or storage. The description may apply to a system, an engine, or a portion thereof.

It will be understood that when a unit, engine or module is referred to as being “on,” “connected to,” or “coupled to,” another unit, engine, or module, it may be directly on, connected or coupled to, or communicate with the other unit, engine, or module, or an intervening unit, engine, or module may be present, unless the context clearly indicates otherwise. As used herein, the term “and/or” includes any and all combinations of one or more of the associated listed items.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of the present disclosure. It is to be expressly understood, however, that the drawings are for the purpose of illustration and description only and are not intended to limit the scope of the present disclosure. It is understood that the drawings are not to scale.

Provided herein are systems and components for interaction with an application (e.g., a virtual character application 431). The present disclosure intends to provide an intelligent application that better understands a user of the application and his or her intention operations. By processing user information, intention data of indicative of an intention operation of a user may be generated, based on which the intention operation of the user may further be executed by the application. Thus, a more convenient interaction between the user and the application may be achieved.

For illustration purposes, the disclosure describes systems and methods for interaction with an application implemented on an interaction system. It should be noted that the interaction system 100 described below is merely provided for illustration purposes, and not intended to limit the scope of he present disclosure.

FIG. 1 is a schematic diagrams illustrating an exemplary interaction system according to some embodiments of the present disclosure. As shown in FIG. 1, the interaction system 100 may include a head-mounted display device 110, a network 120, a terminal 130, a processing engine 140, and a storage 150. The connection between the components in the interaction system 100 may be variable. Merely by way of example, as illustrated in FIG. 1, the head-mounted display device 110 may be directly connected to the processing engine 140 and/or be connected to the processing engine 140 through the network 120.

The head-mounted display device 110 (or referred to as a HMD 110) may refer to a device that may be worn on a user's face and/or head to provide interaction with a user 115. In some embodiments, the HMD 110 may collect information. For example, the HMD 110 may include a sensor which may collect information related to the user. Detailed description may be found elsewhere in the present disclosure. In some embodiments, the HMD 110 may be implemented by an application (e.g., a game application, a social application, a shopping application, etc.) to interact with the user 115. The HMD 110 may interact with the user 115 though virtual contents displayed, for example, on the HMD 110. As used herein, the virtual contents may include objects that may not exist in the real world. The virtual contents may include text, image, audio information, etc. Merely by way of example, the virtual contents may include a virtual character that may perform communicative functions with a user 115. The virtual character may include a virtual person, a virtual humanoid, a virtual human face, or a virtual creature, or the like, or any combination thereof. As another example, the virtual contents may include an audio message that may be provided to a user 115. As another example, the virtual contents may include a text information that may be displayed on a display device (e.g., the HMD 110).

In some embodiments, the HMD 110 may include an eyeglass, a helmet, a smart glasses, a smart helmet, a smart visor, a smart face shield, a smart contact lenses, a virtual reality device, an augmented reality device, or the like, or any combination thereof. For example, the HMD 110 may include a Google Glass™, an Oculus Rift™, a Hololens™, a Gear VR™, etc. In some embodiments, the HMD 110 may connect to the processing engine 140, and transmit information to or receive information from the processing engine 140.

The user 115 may be a user of an application implemented on the HMD 110. The user 115 may be a human user (e.g., a human being), a machine user (e.g., a computer configured by a software program to interact with the HMD 110), or any suitable combination thereof (e.g., a human assisted by a machine or a machine supervised by a human). The user 115 is not part of the interaction system 100, but is associated with the HMD 110.

The network 120 may include any suitable network that can facilitate the exchange of information and/or data for the interaction system 100. In some embodiments, one or more components of the interaction system 100 may communicate information and/or data with one or more other components of the interaction system 100 via the network 120. For example, the processing engine 140 may obtain information from the HMD 110 via the network 120. As another example, the processing engine 140 and/or the HMD 110 may obtain user instructions from the terminal(s) 130 via the network 120. The network 120 may be and/or include a public network (e.g., the Internet), a private network (e.g., a local area network (LAN), a wide area network (WAN)), etc.), a wired network (e.g., an Ethernet network), a wireless network (e.g., an 502.11 network, a Wi-Fi network, etc.), a cellular network (e.g., a Long Term Evolution (LTE) network), a frame relay network, a virtual private network (“VPN”), a satellite network, a telephone network, routers, hubs, witches, server computers, and/or any combination thereof. Merely by way of example, the network 120 may include a cable network, a wireline network, a fiber-optic network, a telecommunications network, an intranet, a wireless local area network (WLAN), a metropolitan area network (MAN), a public telephone switched network (PSTN), a Bluetooth™ network, a ZigBee™ network, a near field communication (NFC) network, or the like, or any combination thereof. In some embodiments, the network 120 may include one or more network access points. For example, the network 120 may include wired and/or wireless network access points such as base stations and/or internet exchange points through which one or more components of the Interaction system 100 may be connected to the network 120 to exchange data and/or information.

The terminal(s) 130 may include a mobile device 131, a tablet computer 132, a laptop computer 133, or the like, or any combination thereof. In some embodiments, the mobile device 131 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, eyeglasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a tablet computer, a desktop, or the like, or any combination thereof. In some embodiments, the virtual reality device and/or the augmented reality device may include a virtual reality helmet, virtual reality glasses, a virtual reality patch, an augmented reality helmet, augmented reality glasses, an augmented reality patch, or the like, or any combination thereof. For example, the virtual reality device and/or the augmented reality device may include a Google Glass™, an Oculus Rift™, a Hololens™, a Gear VR™, etc. In some embodiments, the terminal(s) 130 may be part of the processing engine 140.

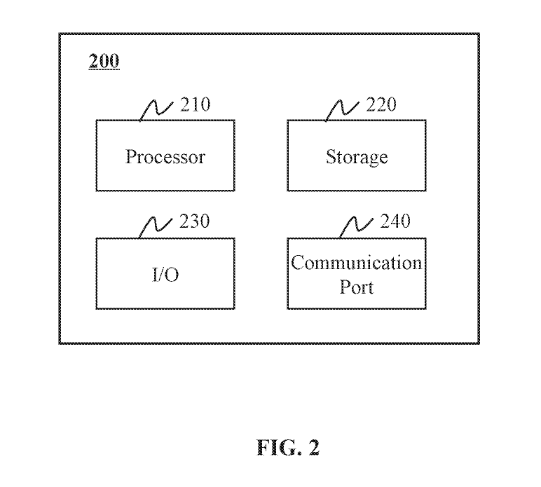

The processing engine 140 may process data and/or information obtained from the HMD 110, the terminal(s) 130, and/or the data storage 150. For example, the processing engine 140 may process information from the HMD 110. The information may be collected by the HMD 110 or may be input by a user 115 though the HMD 110. As another example, the processing engine 140 may generate an instruction based on the received information. The generated instruction may further be sent to and executed by the HMD 110. In some embodiments, the processing engine 140 may be a single server or a server group. The server group may be centralized or distributed. In some embodiments, the processing engine 140 may be local or remote. For example, the processing engine 140 may access information and/or data stored in the HMD 110, the terminal(s) 130, and/or the data storage 150 via the network 120. As another example, the processing engine 140 may be directly connected to the HMD 110, the terminal(s) 130 and/or the data storage 150 to access stored information and/or data. In some embodiments, the processing engine 140 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the processing engine 140 may be implemented by a computing device 200 having one or more components as illustrated in FIG. 2.

The data storage 150 may store data, instructions, and/or any other information. In some embodiments, the data storage 150 may store data obtained from the terminal(s) 130 and/or the processing engine 140. In some embodiments, the data storage 150 may store data and/or instructions that the processing engine 140 may execute or use to perform exemplary methods described in the present disclosure. In some embodiments, the data storage 150 may include a mass storage, removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the data storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the data storage 150 may be connected to the network 120 to communicate with one or more other components in the Interaction system 100 (e.g., the processing engine 140, the terminal(s) 130, etc.). One or more components of the Interaction system 100 may access the data or instructions stored in the data storage 150 via the network 120. In some embodiments, the data storage 150 may be directly connected to or communicate with one or more other components in the Interaction system 100 (e.g., the processing engine 140, the terminal(s) 130, etc.). In some embodiments, the data storage 150 may be part of the processing engine 140.

This description is intended to be illustrative, and not to limit the scope of the present disclosure. Many alternatives, modifications, and variations will be apparent to those skilled in the art. The features, structures, methods, and characteristics of the exemplary embodiments described herein may be combined in various ways to obtain additional and/or alternative exemplary embodiments. However, those variations and modifications do not depart the scope of the present disclosure. For example, the processing engine 140 may be omitted, and the function of the processing engine 140 may be realized by a processor 430 implemented on the HMD 110.

FIG, 2 is a schematic diagram illustrating exemplary hardware and/or software components of an exemplary computing device on which the processing engine 140 may be implemented according to some embodiments of the present disclosure. As illustrated in FIG. 2, the computing device 200 may include a processor 210, a storage 220, an input/output (I/O) 230, and a communication port 340.

The processor 210 may execute computer instructions (e.g., program code) and perform functions of the processing engine 140 in accordance with techniques described herein. The computer instructions may include, for example, routines, programs, objects, components, data structures, procedures, modules, and functions, which perform particular functions described herein. For example, the processor 210 may process medical data obtained from the scanner 110, the terminal 130, the storage device 150, and/or any other component of the medical system 100. In some embodiments, the processor 210 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor 210 of the computing device 200 executes both step A and step B, it should be understood that step A and step B may also be performed by two or more different processors jointly or separately in the computing device 200 (e.g., a first processor executes step A and a second processor executes step B, or the first and second processors jointly execute steps A and B).

The storage 220 may store data/information obtained from the scanner 110, the terminal 130, the storage device 150, and/or any other component of the medical imaging system 100. In some embodiments, the storage 220 may include a mass storage, a removable storage, a volatile read-and-write memory, a read-only memory (ROM), or the like, or any combination thereof. For example, the mass storage may include a magnetic disk, an optical disk, a solid-state drive, etc. The removable storage may include a flash drive, a floppy disk, an optical disk, a memory card, a zip disk, a magnetic tape, etc. The volatile read-and-write memory may include a random access memory (RAM). The RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. The ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage may store one or more programs and/or instructions to perform exemplary methods described in the present disclosure. For example, the storage may store a program for the processing engine 130 for determining a regularization item.

The I/O 230 may input and/or output signals, data, information, etc. In some embodiments, the I/O 230 may enable a user interaction with the processing engine 140. In some embodiments, the I/O 230 may include an input device and an output device. Examples of the input device may include a keyboard, a mouse, a touch screen, a microphone, or the like, or any combination thereof. Examples of the output device may include a display device, a loudspeaker, a printer, a projector, or the like, or any combination thereof. Examples of the display device may include a liquid crystal display (LCD), a light-emitting diode (LED)-based display, a flat panel display, a curved screen, a television device, a cathode ray tube (CRT), a touch screen, or the like, or any combination thereof.

The communication port 240 may be connected to a network (e.g., the network 120) to facilitate data communications. The communication port 240 may establish connections between the processing engine 140 and the scanner 110, the terminal 130, and/or the storage device 150. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G, etc.), or the like, or any combination thereof. In some embodiments, the communication port 240 may be and/or include a standardized communication port, such as RS232, RS485, etc. In some embodiments, the communication port 240 may be a specially designed communication port. For example, the communication port 240 may be designed in accordance with the digital imaging and communications in medicine (DICOM) protocol.

Those skilled in the art will recognize that the present teachings are amenable to a variety of modifications and/or enhancements. For example, although the implementation of various components described herein may be embodied in a hardware device, it may also be implemented as a software only solution, for example, an installation on an existing server. In addition, the processing engine 130 as disclosed herein may be implemented as a firmware, firmware/software combination, firmware/hardware combination, or a hardware/firmware/software combination.

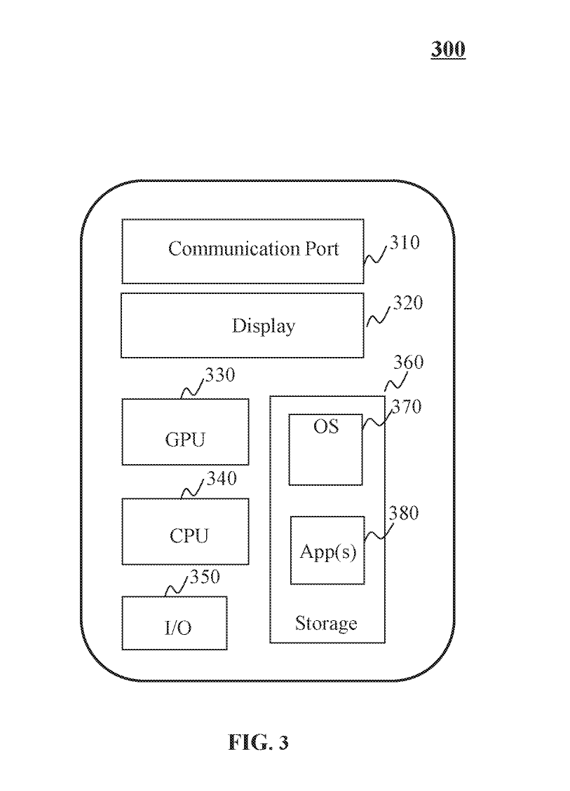

FIG. 3 is a schematic diagram illustrating exemplary hardware and/or software components of an exemplary mobile device 300 on which the terminal 130 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the processing engine 140. User interactions with the information stream may be achieved via the I/O 350 and provided to the processing engine 140 and/or other components of the medical imaging system 100 via the network 120.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a server if appropriately programmed.

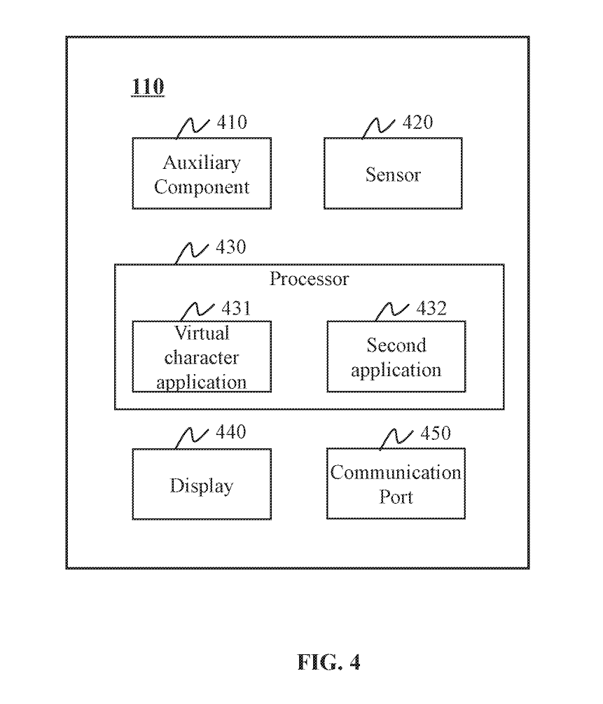

FIG. 4 is a block diagram illustrating an exemplary head-mounted display device 110 according to some embodiments of the present disclosure. As illustrated in FIG. 4, the HMD 110 may include an auxiliary component 410, a sensor 420, a processor 430, a display 440, and a communication port 450. The processor 430 may be implemented by a virtual character application 431 and a second application 432. More or less components may be included in the processing engine without loss of generality. For example, two of the units may be combined into a single unit, or one of the units may be divided into two or more units. In one implementation, one or more of the unit may reside on a same or different computing devices (e.g., different server computers).

A user 115 may wear the HMD 110 on through the auxiliary component. In some embodiments, the auxiliary component 410 may be worn on the user's face or head. Merely by way of example, the auxiliary component 410 may include an eyeglass, a helmet, a visor, a face shield, a contact lenses, or the like or any combination thereof.

The sensor 420 may be configured to collect information related to the user and conditions ambient to the HMD 110. As user herein, the information related to the user may also be referred to as user information, and the conditions ambient to the HMD 110 may also be referred to as context information. In some embodiments, the user information may include physiological information of the user and information input by the user 115. For example, the user information may include a heart rate of the user, a blood pressure of the user, brain activity of the user, biometric data related to the user, a facial image of the user, an expression of the user, an action performed by the user, or an audio given out by the user. As another example, the user information may include information input by the user through an input device including a keyboard, a mouse, a microphone, or the like, or any combination thereof. In some embodiments, the context information may include data of the ambient environment of the HMD 110. Exemplary context information may include an ambient temperature, an ambient humidity level, an ambient pressure, a geographic location of the HMD, an orientation and position of the HMD.

In some embodiments, the sensor 420 may include an image sensor (e.g., a camera), an audio sensor (e.g., a microphone), a location sensor, a humidity sensor, a biometric sensor, an ambient light sensor, or the like or any combination thereof. Merely by way of example, the image sensor may be configured to collect a facial image of the user, and the microphone may be configured to collect audio message given out by the user, and the location sensor may be configured to collect at least one of the geographic location of the HMD, the orientation of the HMD, or the position of the HMD 110 In some embodiments, the sensor 420 may be connected to or communicate with the processing engine 140, and transmit the collected information (e.g., the user information and/or the context information) to the processor 430.

The processor 430 may be configured process information and/or data received from one or more components of the interaction system (e.g., the sensor 420, the terminal 130, the storage, etc.). The information and/or data may include user information, historical operation data of the user, and/or recommendation data of the user.

The processor 430 may process the received information and/or data to determine intention data. As used herein, intention data of a user may refer to data indicative of an intention operation of the user. The indication data may be embodied as an electrical file including a text, an image, or an instruction that can be executed by the processor 430. In some embodiments, the processor 430 may process user information to generate intention data of a user. Merely by way of example, the processor 430 may receive an audio message (e.g., “turn off the media player”) given out by the user. The processor 430 may process the audio message to generate intention data indicating that the intention operation of the user is to turn on the media player. In some embodiments, the processor 430 may process the user information and the historical operation data of the user to determine intention data of the user. As used herein, the historical operation data of the user may include operation information and timing information of the user during a certain time period. For example, the historical operation data may include that the user logged in a website, and when the user logged in the website, and how much time did the user spend on viewing the website. In some embodiments, the processor 430 may process the recommendation data, historical operation data of the user, and user information of the user to determine the intention data. As used herein, the recommendation data may include data selected by the interaction system 100 to recommend to the user. Merely by way of example, the process may select a second set of recommendation data from the received recommendation data (or referred to as a first set of recommendation data) based on historical operation data of the user, and generate the intention data based on the user information and the second set of recommendation data.

The processor 430 may be implemented by one or more applications. For example, the processor 430 may be implemented by a virtual character application 431. As used herein, a virtual character application 431 may refer to an application being configured to perform interactive functions with a user through a virtual character (a virtual person, a virtual humanoid, a virtual human face, a virtual creature, a virtual servicer, etc.). As another example, a virtual application (or referred to as a first application) and a second application 432 (e.g., a game application, a social application, a shopping application, etc.) or an operating system (not shown) may be implemented on the processor 430. As used herein, a first application and/or a second application may refer to a computer program stored on a computer readable storage media, such as a CD disc, diskette, tape, or other media. An operating system (OS) may refer to a system software that manages computer hardware and software resources. Exemplary operating systems may include any version or variation of an Android operating system, an Unix and Unix-like operating systems, a Mac operating system, a Linux operating system, a BlackBerry operating system, a Microsoft Windows operating system comprising Windows 95, Windows 98, Windows NT, Windows 2000, Windows ME, Windows XP and others. The first application may connect to the second application 432 (and/or the operating system) through a link. In some embodiments, a virtual character application 431 and one or more applications may be implemented on the processor 430. The virtual character application 431 may connect to one or more second applications 432 (and/or operating systems) through one or more links, and is configured to execute the one more second applications 432 (and/or operating systems) through the one or more links. In some embodiments, the virtual character application 431 may generate a virtual character based on the intention data of a user. Merely by way of example, the virtual character application 431 may generate at least one characteristic of the virtual character based on the intention data. Exemplary characteristics of a virtual character may include at least one of an action of the virtual character, an operation of the virtual character, an expression of the virtual character, a voice of the virtual character, or an image of the virtual character.

The processor 430 may process the received information and/or data to determine whether to execute an application implemented on the processor 430. For example, the processor 430 may determine whether to execute the virtual character application 431. As another example, the processor 430 may determine whether to execute the virtual character application 431 to invoke a link to the second application 432 (and/or the operating system). The process may determine to execute the application under a certain condition. In some embodiments, the processor 430 may process the received information and/or data to determine whether a trigger condition is satisfied, and determine to execute the application (e.g., the virtual character application 431) in response to a determination that the trigger condition is satisfied. Exemplary trigger condition may be illustrated elsewhere in the present disclosure. In some embodiments, the processor 430 may process the received information and/or data to determine whether an interactive operation is performed by a user 115, and determine to execute the application in response to the determination that the interactive operation is performed by the user 115. Exemplary interactive operation may be found elsewhere in the present disclosure.

The processor 430 may execute the determined intention operation of the user. The processor 430 may execute the determined intention operation of the user through an application implemented on the processor 430. For example, the processor 430 may execute the determined intention operation of the user. As another example, the processor 430 may execute a first application (e,g., the virtual character application 431) to invoke a link to the second application 432 (and/or the operating system). The processor 430 may further execute the second application 432 (and/or the operating system) to perform the determined intention operation of the user.

In some embodiments, the processor 430 may send the generated virtual character to the display 440 or the communication port 450. Merely by way of example, the processor 430 may send the virtual character to the communication port 450, through which, the virtual character may be transmitted to other components in the interaction system or an external device located outside the interaction system.

The display 440 may display information. Merely by way of example, the display 440 may display the virtual character, which may be embodied as a virtual servicer. As another example, the display 440 may display one or more sentences, through which an interactive communication between the virtual character and a user may be accomplished.

In some embodiments, the display 440 may be a screen implemented on the HMD. In some embodiments, the display 440 may be a transparent display such as in the visor or face shield of a helmet. In some embodiments, the display 440 may be display lens distinct from the visor or face shield of the helmet.

The communication port 450 may establish connections between the processor 430 and one or more other components in the interaction system and an external device. The connection may be a wired connection, a wireless connection, any other communication connection that can enable data transmission and/or reception, and/or any combination of these connections. The wired connection may include, for example, an electrical cable, an optical cable, a telephone wire, or the like, or any combination thereof. The wireless connection may include, for example, a Bluetooth™ link, a Wi-Fi™ link, a WiMax™ link, a WLAN link, a ZigBee™ link, a mobile network link (e.g., 3G, 4G, 5G, etc.), or the like, or any combination thereof. In some embodiments, the communication port 450 may be and/or include a standardized communication port, such as RS232, RS485, etc. In some embodiments, the communication port may be a specially designed communication port. For example, the communication port 450 may be designed in accordance with the digital imaging and communications in medicine (DICOM) protocol.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the display 440 may locate outside the HMD 110.

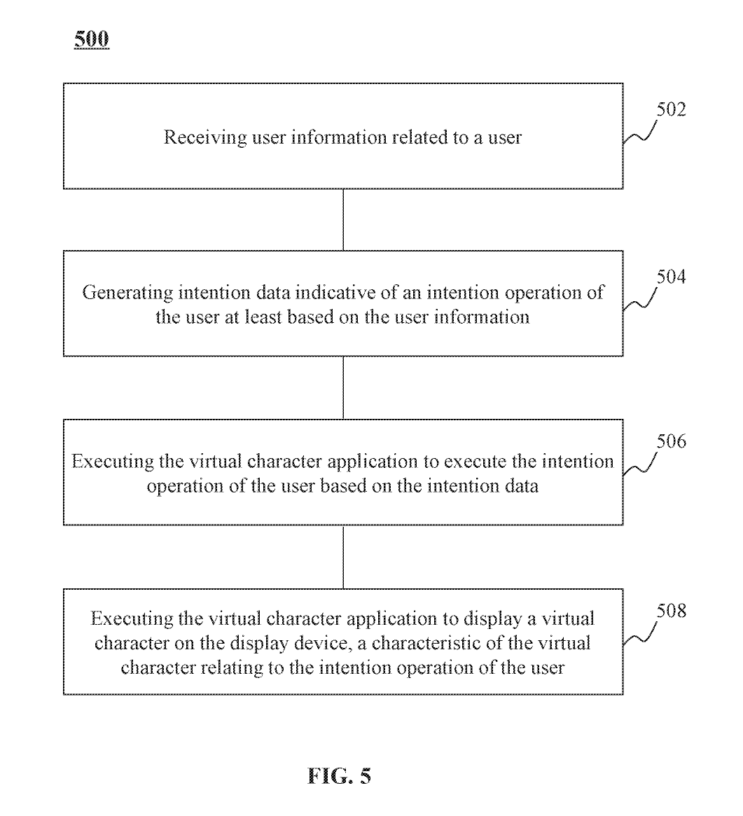

FIG. 5 is a flowchart illustrating an exemplary process 500 for interaction with an application according to some embodiments of the present disclosure. The process, or a portion thereof, may be implemented on a computing device as illustrated in FIG. 2 or a mobile device as illustrated in FIG. 3. For illustration purposes, the following description is provide with reference to the interaction system 100 as illustrated in FIG. 1. As already described, the interaction system 100 includes a HMD 110 including a processor 430 (as illustrated in FIG. 4).

In 502, the processor 430 may receive user information related to a user. The collecting module 610 may receive user information from one or more components of the interaction system 100. Exemplary user information may include biometric data related to the user, a facial image of the user, an action performed by the user, voice of the user the user, an audio message given out by the user, information input by the user, or the like, or any combination thereof. For example, the processor may receive an audio message (e.g., “turn off the media player”) given out by the user.

In 504, the processor 430 may generate intention data of an intention operation of the user at least based on the user information. The indication data may be embodied as an electrical file including a text, an image, or an instruction that can be executed by the processor 430. The processor 430 may analyze the user information (e.g., facial image of the user, the action of the user, the voice of the user, an audio message given out by the user, or the information input by the user) to generate the intention data. The processor 430 may process the audio message to generate intention data indicating that the intention operation of the user is to turn on the media player.

In 506, the processor 430 may execute the virtual character application to execute the intention operation of the user based on the intention data. In some embodiments, the virtual application may execute the determined intention operation of the user. For example, the virtual character application may turn off the media player. In some embodiments, the processor 430 may execute the virtual character application 431 to invoke a link to the second application 432 (and/or the operating system). The processor 430 may further execute the second application 432 (and/or the operating system) to perform the determined intention operation of the user. Merely by way of example, the second application (and/or the operating system) may include a media player. The virtual character application may send an instruction for turning off the second application (and/or the operating system), to the second application (and/or the operating system). The second application (and/or the operating system) may perform the instruction. Thus, the intention operation may be accomplished.

In 508, the processor 430 may execute the virtual character application to display a virtual character on the display device. A characteristic of the virtual character is related to the intention operation of the user. The virtual character application 431 may generate at least one characteristic of the virtual character based on the intention data. Exemplary characteristics of a virtual character may include at least one of an action of the virtual character, an operation of the virtual character, an expression of the virtual character, a voice of the virtual character, or an image of the virtual character. Merely by way of example, when the processor succeeds in turning on the media player, the processor 430 may generate a virtual character with a smile face, and display the virtual character on the display 440. If the processor 430 fails to turn on the media player, the virtual servicer may generate a virtual character with a sad face, and display the virtual character on the display 440.

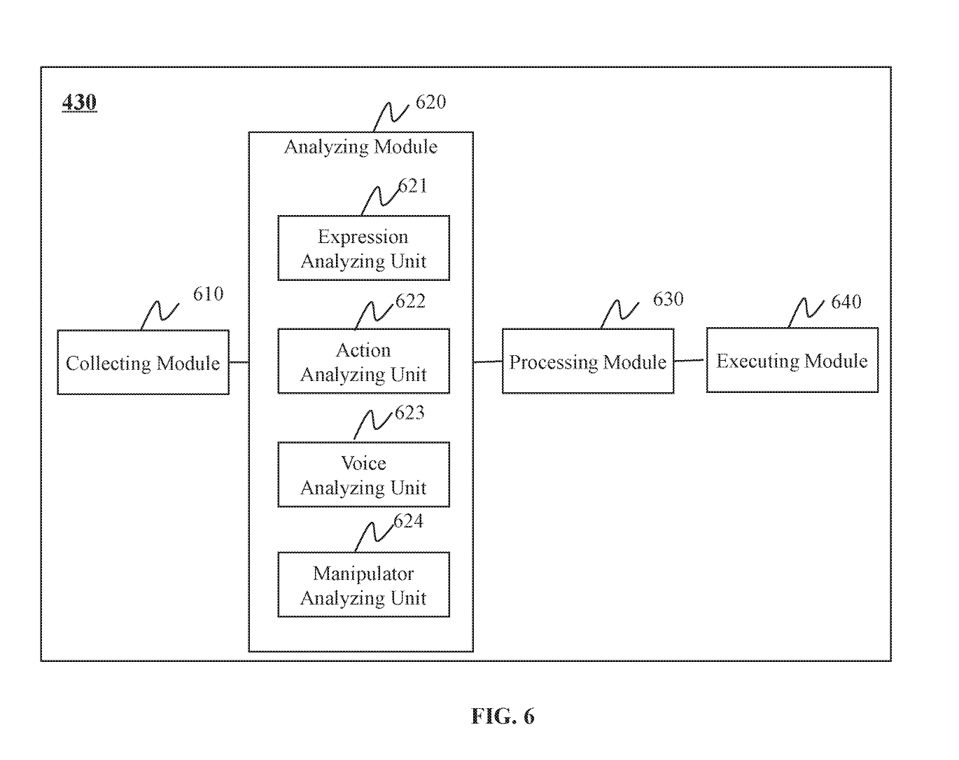

FIG. 6 is a block diagram illustrating an exemplary processor 430 according to some embodiments of the present disclosure. As shown in FIG. 5, the processor 430 may include a collecting module 610, an analyzing module 620, a processing module 630, and an executing module 640. More or less components may be included in the processing engine 140 without loss of generality. For example, two of the units may be combined into a single unit, or one of the units may be divided into two or more units. In one implementation, one or more of the unit may reside on a same or different computing devices (e.g., different server computers). The collecting module 610, analyzing module 620, processing module 630, executing module 640 may be implemented on the processor 430. In some embodiments according to the present disclosure, the collecting module 610 may be implemented on the sensor 420 of the processor 430.

The collecting module 610 may be connected to the analyzing module 620. The collecting module 610 may be configured to collect user information including an expression of a user, an action of a user, a voice of a user and/or information input by the user via a manipulator. The collecting module 610 may be configured to transmit the expression of the user, the action of the user, the voice of the user and/or the information input by the user via the manipulator to the analyzing module 620. For example, the voice of the user may include “turning on the music player”. As another example, the action of the user may include nodding head, shaking head, moving a finger, etc. The manipulator may include a mouse, a keyboard, a handle, a remote controller, a button, a touchpad.

The analyzing module 620 may be connected to the processing module 630. The analyzing module 620 may be configured to receive and analyze the user information (e.g., the expression of the user, the action of the user, the voice of the user, and/or the information input by the user via the manipulator) collected by the collecting module 610. The analyzing module 620 may include an expression analyzing unit 621, an action analyzing unit 622, a voice analyzing unit 623 and/or a manipulator analyzing unit 624. The expression analyzing unit 621 may be configured to analyze an expression of the user. For example, the expression analyzing unit 621 may analyze an emotion and a mental activity of the user based on a facial expression of the user at a certain moment. The action analyzing unit 622 may be configured to analyze an action of the user. For example, when the user browses a shopping website, the action analyzing unit 622 may determine that the user may be interested in an item if the user stares at the item for a relatively long time. Alternatively or additionally, the action analyzing unit 622 may be configured to analyze an action of the user's finger. The voice analyzing unit 623 may analyze voices of the user and determine semantics corresponding to the voices of the user. The manipulator analyzing unit 624 may be configured to analyze information input via the manipulator.

The processing module 630 may be connected to the executing module 640. The processing module 630 may be configured to comprehensively process analyzing results of the analyzing units to determine an operation to be performed by the user (or referred to as an intention operation of the user). The analyzing units may include the expression analyzing unit 621, the action analyzing unit 622, the voice analyzing unit 623 and/or the manipulator analyzing unit 624. The processing module 630 may be configured to transmit the operation to be performed by the user to the executing module 640. By comprehensively processing the user information including the expression of the user, the action of the user, the voice of the user and/or information input by the user via the manipulator, the processing module 630 may simplify a process for a human-computer interaction and improve an experience of the human-computer interaction. Alternatively or additionally, the processing module 630 may be able to determine the operation to be performed by the user more accurately. If the operation to be performed by the user is determined based on one kind of the expression, the action or the voice of the user, the determination result may be less accurate.

The executing module 640 may be configured to display a virtual character (e.g., a virtual servicer) and allow the virtual character to execute the operation to be performed by the user. The executing module 640 may feed an execution result of the execution of the intention operation of the user (or referred to as an operation result) back to the user. For example, the virtual servicer may include a virtual person, a virtual humanoid, a virtual human face, a virtual creature, or the like, or any combination thereof. The executing module 640 may feed the execution result back to the user based on an action of the virtual servicer, an operation of the virtual servicer, an expression of the virtual servicer, a voice of the virtual servicer, and/or an image of the virtual servicer. For example, when the operation to be performed by the user is for turning on the music player, the executing module 640 may turn on the music player through the virtual servicer. If the executing module 640 succeeds in turning on the music player, the virtual servicer may feed a smile face back to the user. If the executing module 640 fails to turn on the music player, the virtual servicer may feed a sad face back to the user. Thus, the executing module 640 (or the virtual character) may improve the experience of the human-computer interaction. The executing module 640 may include a displaying module (not shown in FIG. 6). The displaying module may be configured to display the virtual servicer. The displaying module may include an enclosed head-mounted display (HMD), a helmet, an open HMD, a pair of glasses, a micro projector apparatus, or the like, or any combination thereof.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the processing module 630 may be omitted, and the function of the processing module 630 may be executed by the analyzing module 620.

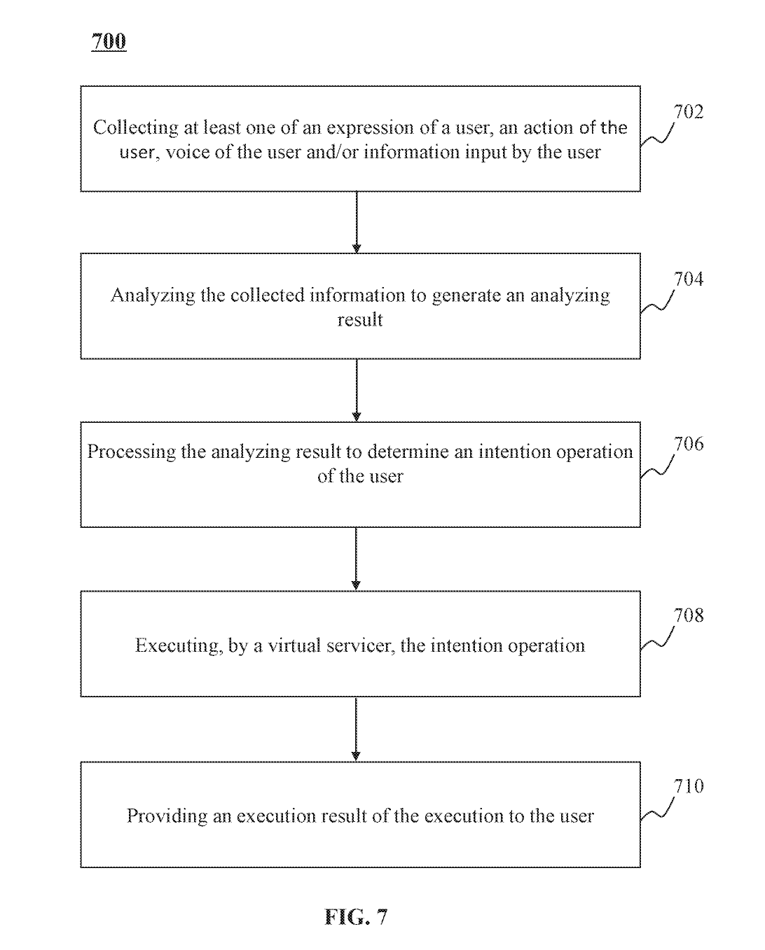

FIG. 7 is a flowchart illustrating an exemplary process 700 for interaction with an application according to some embodiments of the present disclosure. The process, or a portion thereof, may be implemented on a computing device as illustrated in FIG. 2 or a mobile device as illustrated in FIG. 3. For illustration purposes, the following description is provide with reference to the interaction system 100 as illustrated in FIG. 1. As already described, the interaction system 100 includes a HMD 110 including a processor 430 (as illustrated in FIG. 4 and FIG. 6).

In 702, the collecting module 610 may collect at least one of an expression of a user, an action of the user, a voice of the user and/or information input by the user (e.g., via a manipulator). The collecting module 610 may transmit the expression of the user, the action of the user, the voice of the user and/or information input by the user via the manipulator to the analyzing module 620.

In 704, the analyzing module 620 may analyze the collected information to generate one or more analyzing results. In some embodiments, the analyzing module 620 may analyze the expression of the user, the action of the user, the voice of the user and/or information input by the user via the manipulator. The analysis performed by the analyzing module 620 may include a local analysis or an online analysis. A process for the analysis may include a voice recognition, a semantic analysis, an action recognition, an action analysis, an expression recognition, an expression analysis, a recognition and an analysis of the information input via the manipulator, or the like, or any combination thereof.

In 706, the processing module 630 may process the one or more analyzing results to determine an intention operation of the user. In some embodiments, the processing module 630 may comprehensively process the analyzing results of the expression of the user, the action of the user, the voice of the user, and/or information input by the user via the manipulator, to determine an operation to be performed by the user.

In 708, the executing module 640 may execute the intention operation by a virtual character. In some embodiments, the executing module 640 may display a virtual servicer and allow the virtual servicer to execute the operation to be performed by the user and feed an operation result back to the user. The operation that the virtual servicer can perform may include opening a file and a program, searching, playing a media, installing and deleting a program, file operations (e.g., sending out the file by e-mail), contact operations, editing a message, sending and receiving, setting and controlling an operating system. As another example, the operation that the virtual servicer can perform may include displaying and operating an item, displaying and operating a service, obtaining an external item or service, searching for life information, chatting with the user (e.g., having a dialogue based on artificial intelligence), an action interaction, an expression interaction. As still another example, the operation that the virtual servicer can perform may include operating a behavior, an action, an expression, a voice, a sound, a feature, a character of the virtual servicer itself, e.g., lengthening a height of a virtual creature. As still another example, the operation that the virtual servicer can perform may include calling out the virtual servicer in an application, interacting with the user based on a condition of the application at that moment, performing an information recognition and operation of a current application, finishing jumping between applications.

In 710, the executing module 640 may provide an execution result of the execution to the user. The executing module 640 may feed the execution result back to the user based on an action of the virtual servicer, an operation of the virtual servicer, an expression of the virtual servicer, a voice of the virtual servicer, and/or an image of the virtual servicer. For example, when the executing module 640 succeeds in executing the intention operation, the virtual servicer may feed a smile face back to the user.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. In some embodiments, the virtual servicer may include a virtual person, a virtual humanoid, a virtual human face and/or a virtual creature. In some embodiments, 710 may include feeding back the operation result to the user 115 through an action, an operation, an expression, a voice, a sound and/or an image of the virtual servicer. In some embodiments, 708 may include proactively initiating the virtual servicer to allow the virtual servicer to initiate the voice interaction, the sound interaction, the action interaction, the mobile interaction, the operation interaction and/or the expression interaction to the user 115. In some embodiments, 708 may include initiating the virtual servicer to allow the virtual servicer to initiate the voice interaction, the sound interaction, the action interaction, the mobile interaction, the operation interaction and/or the expression interaction to the user 115 when a trigger condition is satisfied. In some embodiments, 708 may include initiating the virtual servicer to allow the virtual servicer to initiate the voice interaction, the sound interaction, the action interaction, the mobile interaction, the operation interaction and/or the expression interaction to the user 115 based on an interactive operation of the user. In some embodiments, 706 may include obtaining and/or storing historical data of user operations, and performing data processing based on the historical data and the user operation. In some embodiments, 706 may include obtaining and/or storing recommendation data, selecting a portion of the recommendation data based on the user operations, external information of the system 100, internal information of the system 100, and performing processing based on the selected recommendation data. In some embodiments, the manipulator may include a mouse, a keyboard, a handle, a remote controller, a button and/or a touchpad. In some embodiments, 708 may include performing the following operations by the virtual servicer: opening a file and a program, searching, playing a media, installing and deleting a program, file operations, contact operations, editing a message, sending and receiving, setting and controlling an operating system, displaying and operating an item, displaying and operating a service, obtaining an external item or service, searching for life information, chatting with the user 115, an action interaction, an expression interaction, operating a behavior, an action, an expression, a voice, a sound, a feature, a character of the virtual servicer itself, calling out the virtual servicer in an application, interacting with the user 115 based on a condition of the application at that moment, performing an information recognition and operation of a current application, finishing jumping between applications.

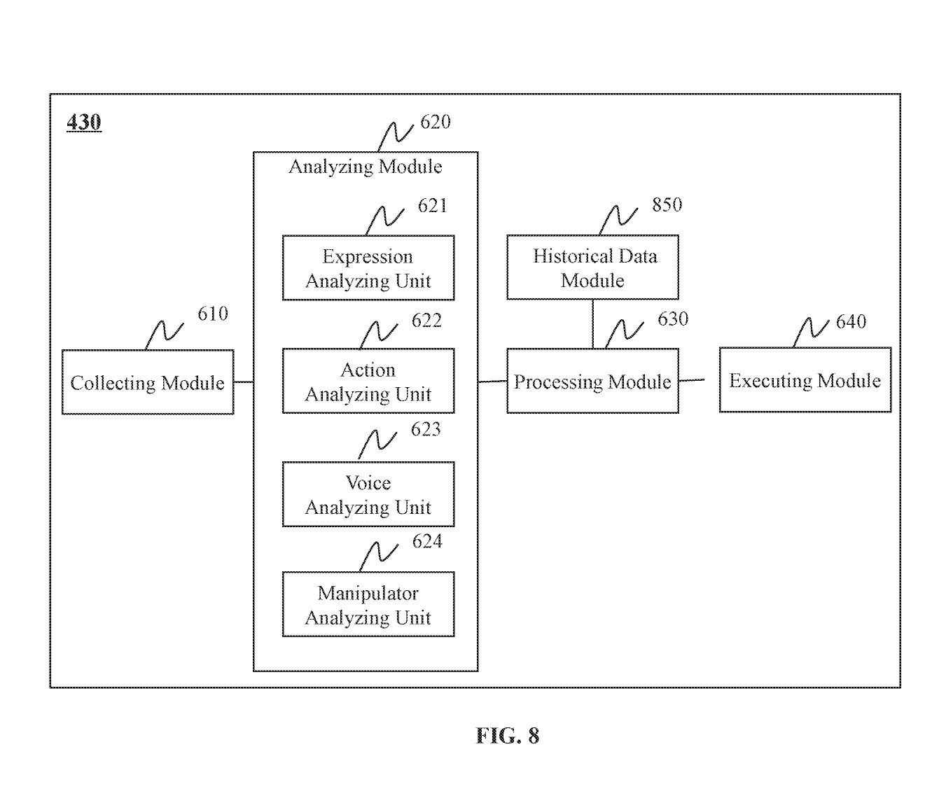

FIG. 8 is a block diagram illustrating an exemplary processor 430 according to some embodiments of the present disclosure. As shown in FIG. 8, the processor 430 may include a collecting module 610, an analyzing module 620, a processing module 630, an executing module 640, and a historical data module 850. The analyzing module 620 may include an expression analyzing unit 621, an action analyzing unit 622, a voice analyzing unit 623 and/or a manipulator analyzing unit 624. The historical data module 850 may be connected to the processing module 630. The historical data module 850 may be configured to obtain and/or store historical data of user operations. The processing module 630 may be configured to read the historical data of the user operations from the historical data module 850 and process the historical data of the user operations. For example, if the user 115 says: “turning on the movie Ice Age”, the virtual servicer may play the movie Ice Age by a media player. The historical data module 850 may record that the user 115 watched at 50^{th} minute last time. The processing module 630 may read and process the historical data recorded in the historical data module 850 to determine that the user 115 possibly wants to watch the movie Ice Age from the 50^{th} minute. The virtual servicer may then start to play the movie Ice Age from the 50^{th} minute, improving the interactive experience of the user 115.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the historical data module 850 may be omitted, and the function of the historical data module 850 may be executed by the collecting module 610.

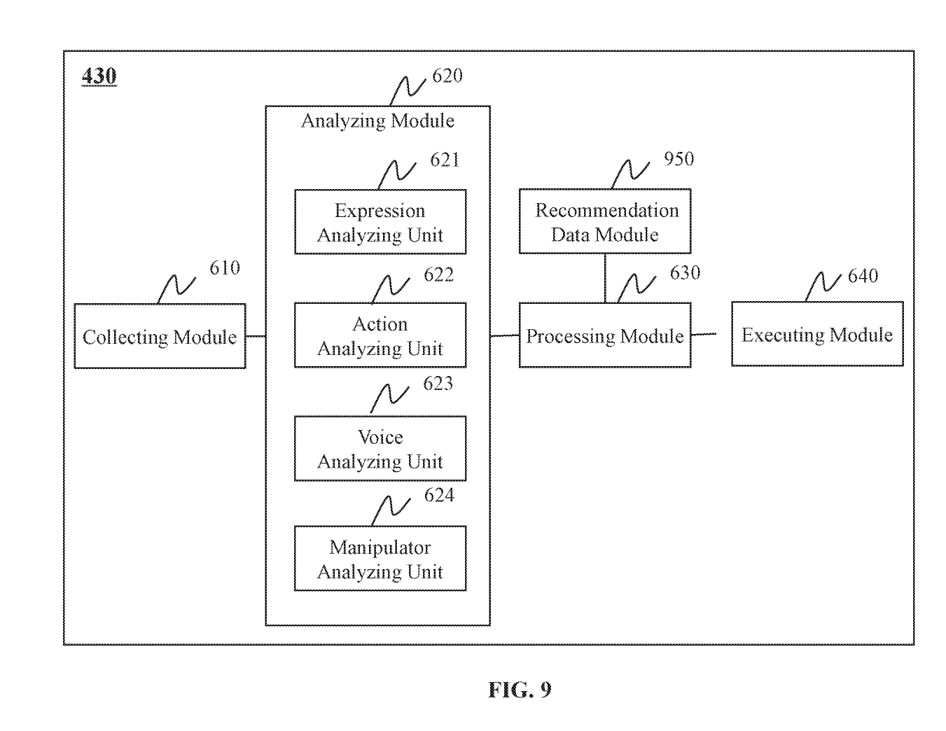

FIG. 9 is a block diagram illustrating an exemplary processor 430 according to some embodiments of the present disclosure.

As shown in FIG. 9, the processor 430 may include a collecting module 610, an analyzing module 620, a processing module 630, an executing module 640, and a recommendation data module 950. The analyzing module 620 may include an expression analyzing unit 621, an action analyzing unit 622, a voice analyzing unit 623 and/or a manipulator analyzing unit 624. The recommendation data module 950 may be connected to the processing module 630. The recommendation data module 950 may be configured to obtain and/or store recommendation data. The processing module 630 may select a portion of the recommendation data from the recommendation data module 950 based on the user operation, external information of the system 100, and internal information of the system 100. The processing module 630 may then process the selected recommendation data. For example, the recommendation data module 950 may store recommendation data of, e.g., “a geographic location of the user is Sichuan”, “the user likes to eat Kung Pao Chicken”, etc. When using the system 100, the user says: turning on the movie Let the Bullets Fly, the virtual servicer may play the movie Let the Bullets Fly by a media player. The processing module 630 may select the recommendation data “the location of the user is Sichuan”, and determine that the user possibly wants to watch the movie Let the Bullets Fly in Sichuan language. The virtual servicer may recommend the movie Let the Bullets Fly in Sichuan language to the user, improving the interactive experience of the user.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the recommendation data module 950 may be omitted, and the function of the historical data module 850 may be executed by the collecting module 610.

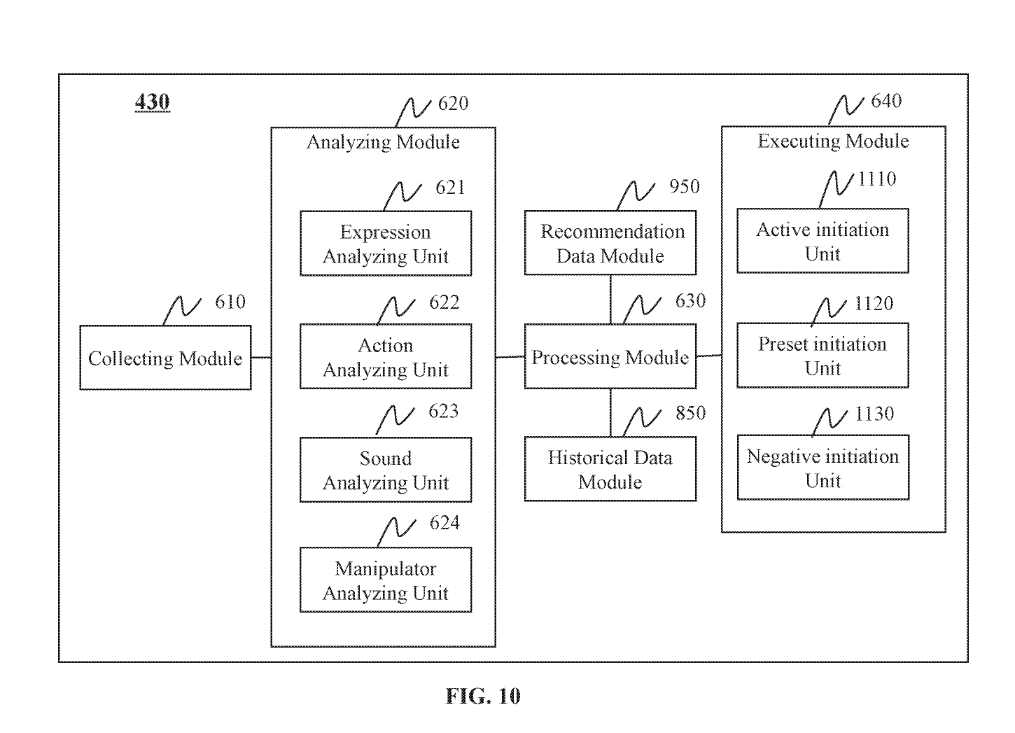

FIG. 10 is a block diagram illustrating an exemplary processor 430 according to some embodiments of the present disclosure.

As shown in FIG. 10, the processor 430 may include the collecting module 610, the analyzing module 620, the processing module 630, and the executing module 640. The collecting module 610, the analyzing module 620, the processing module 630, and the executing module 640 may be connected sequentially. The analyzing module 620 may include the expression analyzing unit 621, the action analyzing unit 622, the voice analyzing unit 623 and the manipulator analyzing unit 624. The processing module 630 may be connected to the historical data module 850 and the recommendation data module 950. The executing module 640 may include the active initiation unit 1110, the trigger-initiation unit 1120 and the passive initiation unit 1130.

The human-computer interaction device may consider the virtual servicer as an interface of the VR, the AR and the MR operating systems. The analyzing module 620 may recognize and analyze an interaction that is initiated by the user to the virtual servicer. The interaction may include the voice interaction, the action interaction, the expression interaction and the manipulator interaction. The processing module 630 may process analyzing results from the analyzing module 620 based on historical data and recommendation data to determine an operation to be performed by the user. The executing module 640 may be configured to display the virtual servicer and perform the operation to be performed by the user by the virtual servicer. Alternatively or additionally, the executing module 640 may feed an operation result back to the user by an action, an operation, an expression, a voice, a sound and/or an image of the virtual servicer. Then a process for the human-computer interaction may be completed. The human-computer interaction device in the present disclosure may provide an intuitive, emotional and humanized human-computer interactive method. The human-computer interaction device in the present disclosure may prioritize the process for the human-computer interaction and make the human-computer interaction intuitive, easy and convenient. Besides, the human-computer interaction device in the present disclosure may improve the efficiency, the experience and the quality of the human-computer interaction.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, the recommendation data module 950 may be omitted, and the function of the historical data module 850 and the recommendation data module 950 may be executed by the collecting module 610.

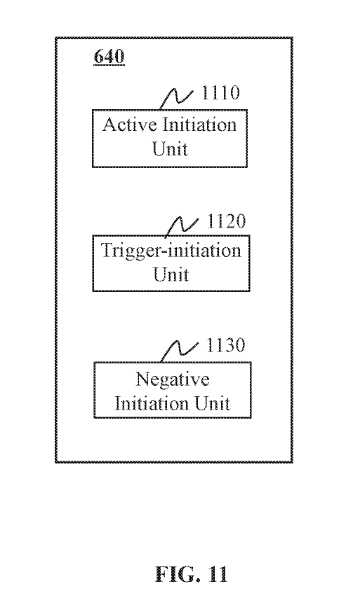

FIG. 11 is a block diagram illustrating an exemplary executing module 640 according to some embodiments of the present disclosure. More or less components may be included in the processing engine 140 without loss of generality. For example, two of the units may be combined into a single unit, or one of the units may be divided into two or more units. In one implementation, one or more of the unit may reside on a same or different computing devices (e.g., different server computers).

As shown in FIG. 11, the executing module 640 may include an active initiation unit 1110, a trigger-initiation unit 1120, and a passive initiation unit 1130. When the user 115 uses products or services of virtual reality (VR), augmented reality (AR) and mix reality (MR), the active initiation unit 1110 may be configured to proactively initiate a virtual servicer (i.e., the virtual servicer may proactively show up). The virtual servicer may initiate a voice interaction, a sound interaction, an action interaction, a mobile interaction, an operation interaction and/or an expression interaction. For example, after the user 115 logs in a VR system, an AR system or a MR system, the virtual servicer may proactively show up, and report today's weather conditions to the user 115 or ask the user 115 what operation the user 115 wants to perform.

When the user 115 uses VR, AR or MR products or services, the trigger-initiation unit 1120 may be configured to initiate the virtual servicer to allow the virtual servicer to initiate an interaction to the user 115 when a trigger condition is satisfied. The interaction may include a voice interaction, a sound interaction, an action interaction, a mobile interaction, an operation interaction and/or an expression interaction. For example, the trigger condition may include: initiating the virtual servicer if the user 115 stares at a refrigerator for 10 seconds when the user 115 is shopping online. In this case, after the user 115 stares at the refrigerator for 10 seconds when the user 115 is shopping online, the trigger-initiation unit 1120 may initiate the virtual servicer. The virtual servicer may introduce information associated with the refrigerator to the user 115 for reference. The information associated with the refrigerator may include detailed parameters of the refrigerator, user evaluations of the refrigerator, etc. Thus it may facilitate the shopping of the user and improve the interaction experience of the user.

When the user 115 uses the VR, the AR or the MR products or services, the passive initiation unit 1130 may be configured to initiate the virtual servicer to allow the virtual servicer to initiate an interaction to the user 115 based on an interactive operation of the user. The interaction may include the voice interaction, the sound interaction, the action interaction, the mobile interaction, the operation interaction and/or the expression interaction. For example, when the user 115 performs an operation of installing a program, the passive initiation unit 1130 may initiate the virtual servicer. The virtual servicer may perform the operation of installing the program and transmit an operation result to the user 115.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

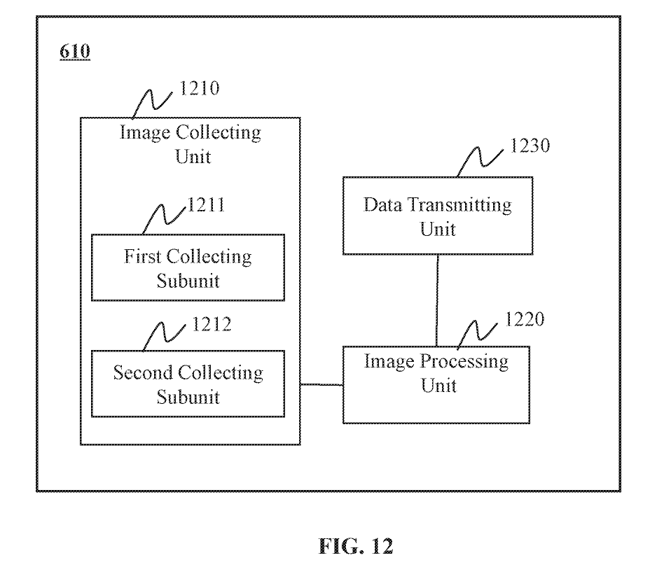

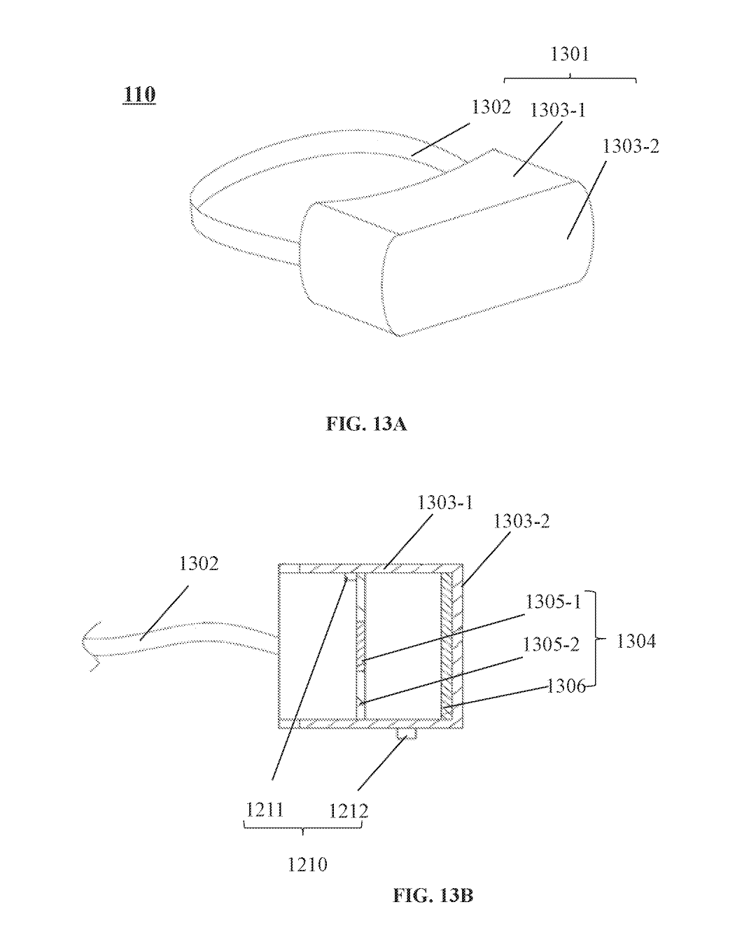

FIG. 12 is a block diagram illustrating an exemplary collecting module 610 according to some embodiments of the present disclosure. FIG. 13A is a schematic diagram illustrating an exemplary head-mounted display device according to some embodiments of the present disclosure. FIG. 13B is a schematic diagram illustrating cross-sectional views illustrating a head-mounted display device according to some embodiments of the present disclosure. The collecting module 610 may be implemented on the head-mounted display device. For example, the collecting module 610 may be implemented on the sensor 420 of the processor 430, which may be implemented on the head-mounted display device.

As shown in 13A, and 13B, a head-mounted display device 110 may include a mounting component 1301, and a display component 1304. The collecting module 610 may include an image collecting unit (or referred to as an image receiver) 1210, an image processing unit (or referred to as an image processor) 1220, and a data transmitting unit 1230. The image collecting unit 1210 may include a first collecting sub-unit 1211 (or referred to as an internal collecting sub-unit) and a second collecting sub-unit (or referred to as an external collecting sub-unit) 1212.

In some embodiments, the display component 1304 may be configured on the mounting component 1301. The image collecting unit 1210 may be configured on the mounting component 1301. The image collecting unit 1210 may be configured to collect a facial image of a user. The image processing unit 1220 may be configured on the mounting component 1301 and connected to the image collecting unit 1210. The image processing unit 1220 may be configured to receive, analyze and process the facial image of the user to recognize an expression of the user.

The image collecting unit 1210 may collect information of a facial image of a user when the user 115 uses the head-mounted display device. The image processing unit 1220 may analyze the information of the facial image and determine an emotion of the user at that moment. By collecting and analyzing the expression of the user, the head-mounted display device may better understand an intention of the user (or referred to as intention operation of the user) and improve an interactive experience of the user. Besides, it may achieve a relatively natural interaction of the user through the VR, AR or MR products. Thus, it may improve the comfort level of using the products and the competitive of the products in the market.

In some embodiments the image collecting unit 1210 may include at least one camera.

In some embodiments, the camera may be configured on a plurality of locations of the mounting component 1301. The camera may collect the facial image of the user from every direction, which may cause more accurately to determine the emotion of the user. Thus it may allow the head-mounted display device to better understand the intention of the user and improve the interactive experience of the user. Besides, it may achieve a relatively natural interaction of the user 115 through the VR, AR or MR products.

In some embodiments, the camera may include an infrared camera.

In some embodiments, the infrared camera may collect clear images under a relatively dark circumstance, which may facilitate the image processing unit 1220 to determine the emotion of the user. Thus it may allow the head-mounted display device to better understand the intention of the user and improve the interactive experience of the user. Besides, it may achieve a relatively natural interaction of the user 115 through the VR, AR or MR products.

It should be noted that the camera illustrated above may not only include the infrared camera, cameras that can collect a facial image of a user are within the protection scope of the present disclosure.

In some embodiments, as shown in FIG. 12, the head-mounted display device may include a data transmitting unit 1230.

In some embodiments, the data transmitting unit 1230 may be configured on the mounting component 1301 and connected to the image processing unit 1220. The data transmitting unit 1230 may be configured to communicate with an external device.

In some embodiments, the data transmitting unit 1230 may transmit information of the image and information of the emotion of the user to the external device, which may facilitate to store and analyze the information of the image and information of the emotion of the user. Thus it may allow the head-mounted display device to better understand the intention of the user and improve the interactive experience of the user. Besides, it may achieve a relatively natural interaction of the user 115 through the VR, AR or MR products.

In some embodiments, the image collecting unit 1210 may be configured to collect the facial image of at least one of a mouth, a nose, facial muscles, eyes, eyebrows, eyelids or a glabella of the user 115.

In some embodiments, the image collecting unit 1210 may be configured to collect at least one of the mouth, the nose, the facial muscles, the eyes, the eyebrows, the eyelids or the glabella of the user 115, which may enable the image collecting unit 1210 to comprehensively collect the facial image of the user. Thus it may allow the head-mounted display device to better understand the intention of the user and improve the interactive experience of the user. Besides, it may achieve a relatively natural interaction of the user through the VR, AR or MR products.

In some embodiments, the image collecting unit 1210 may be detachably configured on the mounting component 1301. The image collecting unit 1210 may be configured with a communication plug. The image processing unit 1220 may be configured with a communication socket. The communication plug may plug into the communication socket such that the image collecting unit 1210 may be connected to the image processing unit 1220 to transmit data (e.g., a facial image of the user) thereto.

In some embodiments, when the image collecting unit 1210 is non-functional, the user 115 may directly pull out the communication plug from the communication socket. The user 115 may then detach the image collecting unit 1210 from the mounting component 1301 and replace the non-functional image collecting unit 1210. When the image collecting unit 1210 of a product is non-functional, the non-functional image collecting unit 1210 may be replaced, and it may extend a service life of the product.

In some embodiments, as shown in FIGS. 13A and 13B, the mounting component 1301may include a shell 1303 and an immobilizing component 1302. The shell 1303 may enclose a chamber. An end of the shell may be configured with an opening connected to the chamber. The shell may include a side panel 1303-1 and a front panel 1303-2. The image collecting unit 1210 may be configured on the side panel 1303-1. The shell 1303 may cover on eyes of the user 115. The immobilizing component 1302 may be connected to the shell 1303 to fix the shell 1303 on the head of the user 115.

In some embodiments, the shell 1303 may cover on the eyes of the user 115. The shell 1303 and the face of the user 115 may form an enclosed chamber, and it may reduce an amount of light emitted into the enclosed chamber, reducing an impact of the ambient light on a sight of the user to allow the user 115 to view contents displayed on the display component 1304 more clearly.

It should be noted that other components that being configured to fix the shell 1303 on the head of the user are within the protection scope of the present disclosure. For example, the immobilizing component 1302 may include a helmet, a fixing belt, a fixed clip, etc.

As shown in FIGS. 13A and 13B, the immobilizing component 1302 may include the fixing belt.

In some embodiments, as shown in FIG. 13B, the image collecting unit 1210 may include an internal collecting sub-unit (or referred to as an internal image receiver) 1211 and an external collecting sub-unit (or referred to as an external image receiver) 1212.

In some embodiments, the internal collecting sub-unit 1211 may be configured inside the containing chamber and fixed on an inner surface of the side panel 1303-1. The external collecting sub-unit 1212 may be configured on an external surface of the side panel 1303-1.

In some embodiments, the internal collecting sub-unit 1211 may collect facial image of eyes of the user and a surrounding thereof. The external collecting sub-unit 1212 may collect facial images of the mouth of the users and a surrounding thereof. Thus, the image collecting unit 1210 to comprehensively collect the facial image of the user. The internal collecting sub-unit 1211, the external collecting sub-unit 1212, and the manner they are configured on the head-mounted display device may further allow the head-mounted display device to better understand the intention of the user and improve the interactive experience of the user. Besides, the internal collecting sub-unit 1211, the external collecting sub-unit 1212, and the manner they are configured on the head-mounted display device may achieve a relatively natural interaction of the user 115 through the VR, AR or MR products.

In some embodiments, as shown in FIG, 13B, the display component 1304 may include a display screen 1306 and a lens component 1305. The display screen 1306 may be configured on the front panel 1303-2. The lens component 1305 may include frames 1305-2 and lenses 1305-1. The frames 1305-2 may be connected to the side panel 1303-1. The lenses 1305-1 may be configured on the frames 1305-2. The user 115 may view the display screen 1306 through the lenses 1305-1.

In some embodiments, the user 115 may watch the display screen 1306 through the lensed 222, and the user 115 may see dynamic views and entity actions of an environment, which may make the user 115 feel immersed in the environment.

In some embodiments, the display screen 1306 may include a curved display screen. In some embodiments, the curved display screen may provide a wide panoramic image effect. Besides, the employment of the curved display screen may reduce an off-axis distortion when the user 115 watches the display screen 1306 within a close range, improving the comfort of using the products and the competitive of the products in the market.

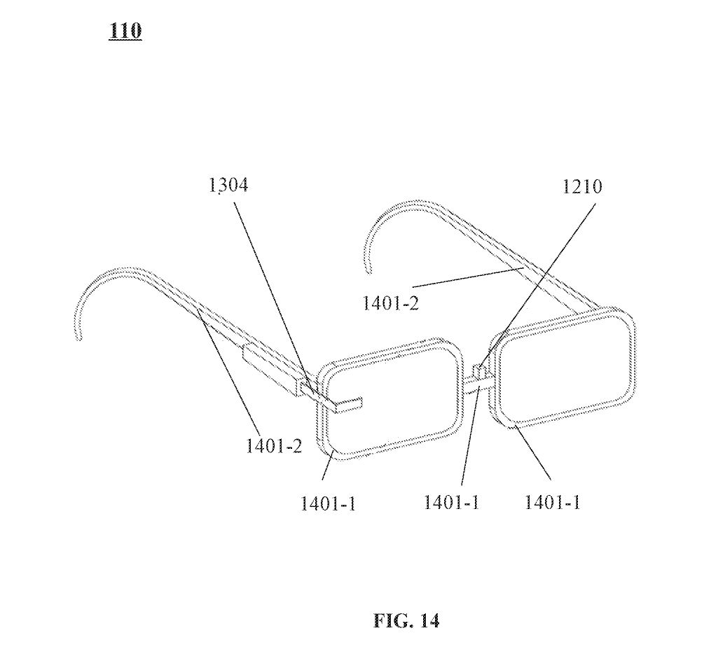

FIG. 14 is a schematic diagram illustrating an exemplary head-mounted display device according to some embodiments of the present disclosure. As shown in FIG. 14, the head-mounted display device may include a mounting component 1401, a display component 1404 and an image collecting unit 1210. Detailed description of the display component 1404 may refer to the description of the display component 1304 in FIG. 13. The mounting component 1401 may include brackets 1401-1 and temples 1401-2.

In some embodiments, the image collecting unit 1210 may be configured on the brackets 1401-1. The display component 1404 may include a projector configured on the mounting component 1401. The projector may be configured to project an image on the eyes of the user 115.

In some embodiments, the projector may project an image on the eyes of the user 115, and the user 115 may see two views of the image. One view of the image may include realistic views, and another view of the image may include virtual views projected by the projector. That is to say, the views seen by the user 115 may include the realistic views and the virtual views, improving a sense of reality of the user experience.

In some embodiments, a projector may be configured on a front of the brackets 1401-1 and connected to the temples 1401-2. In some embodiments, the projector may be configured on two sides of the brackets 1401-1, and the projector may project the images on the eyes of the user from the two sides. In some embodiments, the projector may be configured on an upper of the brackets 1401-1, and the projector may project the images on the eyes of the user from the upper. The projector may directly project the images on the eyes of the user. Alternatively or additionally, the projector may project the images on the lenses(not shown), and then project the images on the eyes of the user through the lenses.

In some embodiments, a process for using the head-mounted display device illustrated in FIG. 13A, FIG. 13B, and/or FIG. 14 may include: mounting the head-mounted display device on the head of a user by the user 115, collecting a facial image of the user by the image collecting unit 1210 (i.e., collecting a facial expression of the user and transmitting a signal of the facial image by the image collecting unit 1210), receiving the signal of the facial image and processing the signal to determine the emotion of the user by the image processing unit 1220. Thus the analyzing of the image processing unit 1220 may allow the head-mounted display device to better understand the intention of the user and improve the interactive experience of the user. Besides, it may achieve a relatively natural interaction of the user 115 through the VR, AR or MR products.

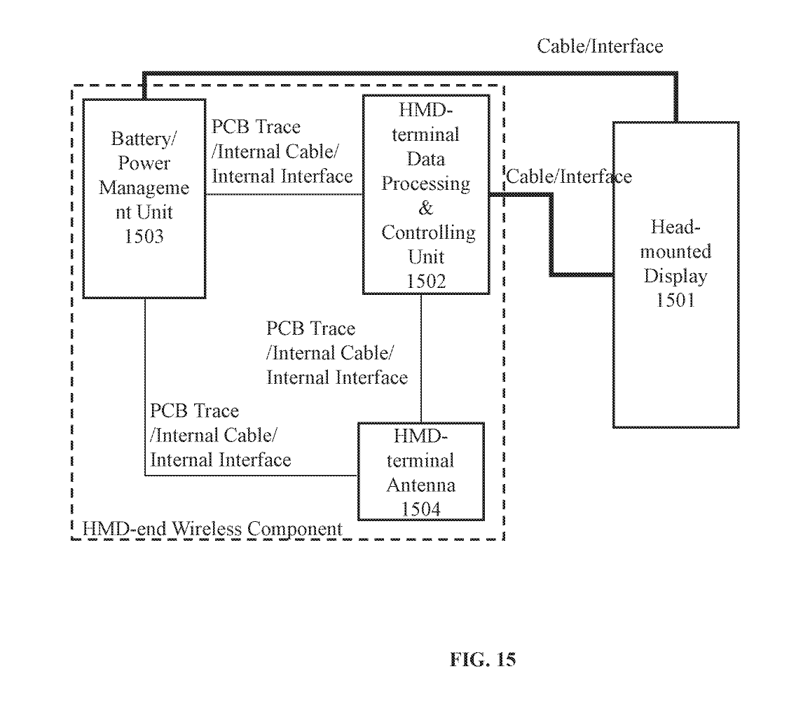

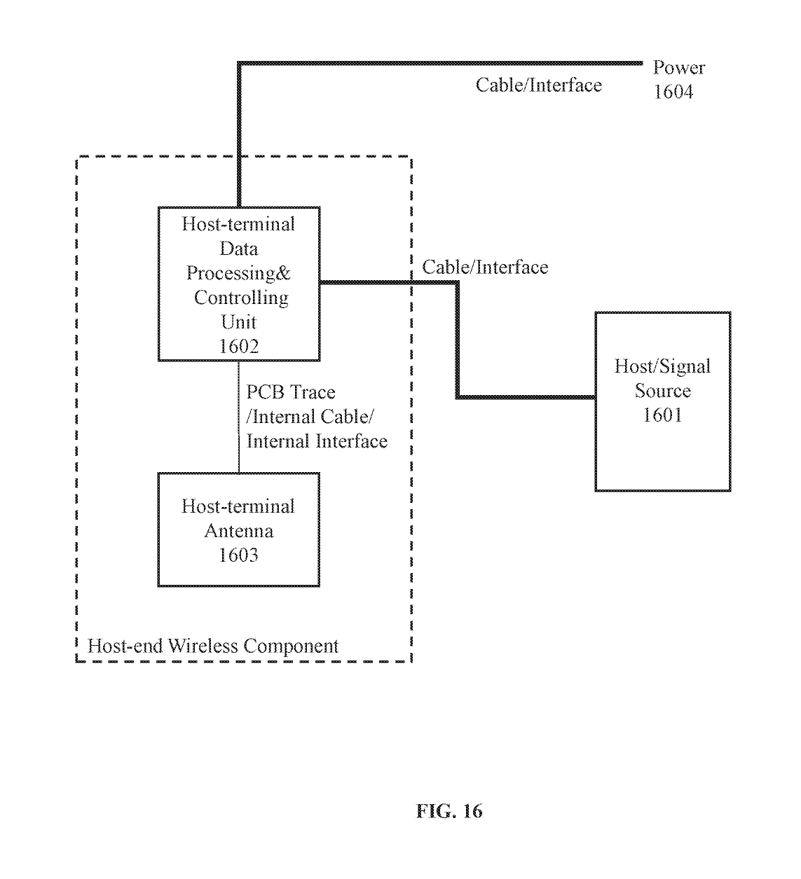

FIG. 15 is a schematic diagram illustrating an exemplary head-mounted display device according to some embodiments of the present disclosure. As shown in FIG. 15, the HMD-end wireless component 1500 may include a battery and a power management unit 1503, a HMD-end data processing and controlling unit 1502 and a HMD-end antenna 1504. The battery and the power management unit 1503 may be connected to a HMD 1501 (or referred to as a HMD device 1501) via a cable (or referred to as a first cable) or a connector (or referred to as a first connector). The battery and the power management unit 1503 may be connected to the HMD-end data processing and controlling unit 1502 and the HMD-end antenna 1504 via a PCB Trace, an internal cable (or referred to as a first internal cable) or an internal connector (or referred to as a first internal connector). The HMD-end data processing and controlling unit 1502 may be connected to the HMD 1501 via the cable (or referred to as the first cable) and the connector (or referred to as the first connector). The HMD-end data processing and controlling unit 1502 may be connected to the HMD-end antenna 1504 via the PCB (Printed Circuit Board) Trace, the internal cable (or referred to as a first internal cable) or the internal connector (or referred to as a first internal connector). In some embodiments, the first cable, or the first internal cable, may include one or more cables. The first connector, or the first internal connector may include one or more connectors. FIG. 16 is a schematic diagram illustrating an exemplary processing engine 140 according to some embodiments of the present disclosure. The processing engine 1601 may also be referred to as a host 1601. As shown in FIG. 16, the host-end wireless component 1600 may include a host-end data processing and controlling unit 1602 and a host-end antenna 1603. The host-end data processing and controlling unit 1602 may be connected to a power 1604 via a cable (or referred to as a second cable) or a connector (or referred to as a second connector). The host-end data processing and controlling unit 1602 may be connected to the host-end antenna 1603 via a PCB Trace, an internal cable (or referred to as a second internal cable) or an internal connector (or referred to as a second internal connector). The host-end data processing and controlling unit 1602 may be connected to a host or a signal resource 1601 via the cable (or referred to as a second cable) or the connector (or referred to as a second connector). In some embodiments, the second cable, or the second internal cable, may include one or more cables. The second connector, or the second internal connector may include one or more connectors.

The HMD-end data processing and controlling unit 1502 may be paired to host-end data processing and controlling unit 1602. Data transmitted by the host or the signal resource 1601 may be processed by the host-end data processing and controlling unit 1602. The processed data may be sent out by the host-end antenna 1603. The HMD-end antenna 1504 may receive data sent out by the host-end antenna 1603, and send the received data to the HMD-end data processing and controlling unit 1502. The H MD-end data processing and controlling unit 1502 may process (e.g., examine) the received data, and further send the processed data to the HMD 1501 via the cable (or referred to as the first cable) or the connector (or referred to as the first connector). The HMD 1501 may send out data which may be processed by the HMD-end data processing and controlling unit 1502 via the HMD-end antenna 1504. The host-end antenna 1603 may receive the data, process (e.g., examine) the data with the host-end data processing and controlling unit 1602, and send the processed data to the host or the signal resource 1601. In some embodiments, the data sent out by the HMD-end antenna 1504 to the host-end antenna 1603 may be in the form of a signal (e.g., an electrical signal). The signal may relate a location of the HMD 1501 or a motion of the HMD 1501.

In some embodiments, to transmit data between the HMD-end data processing and controlling unit 1502 and the HMD 1501, a High-definition Multimedia Interface (HDMI), a Display Port, a Universal Serial Bus Type C (USB Type-C), a Mobile Industry Processor Interface (MIPI), a Low Voltage Differential Signaling (LVDS), a V-by-One® HS port (V-by-One), a Universal Serial Bus (USB), or a Thunder Bolt may be used.

In some embodiments, to transmit data between the host-end data processing and controlling unit 1602 and the host-end antenna 1603, a High-definition Multimedia Interface (HDMI), a Display Port, a Universal Serial Bus Type C (USB Type-C), a Mobile Industry Processor Interface (MIPI), a Low Voltage Differential Signaling (LVDS), a V-by-One® HS port (V-by-One), a Universal Serial Bus (USB), or a Thunder Bolt may be used.

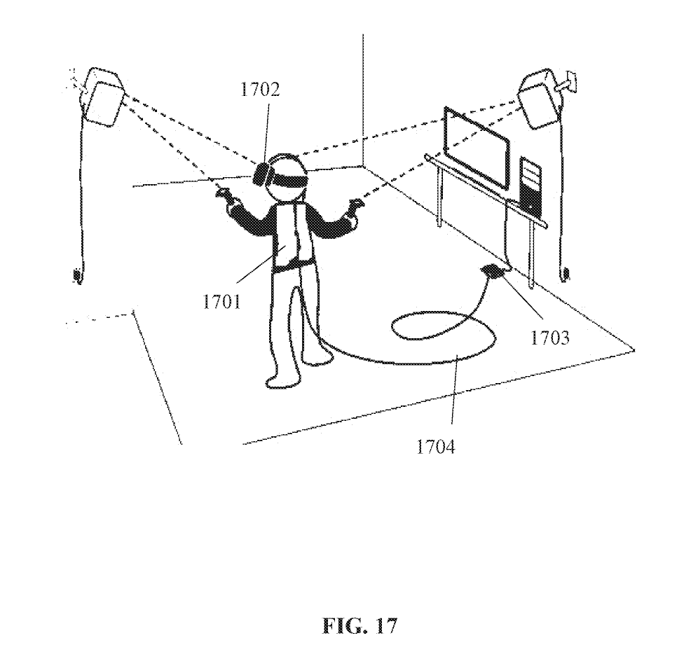

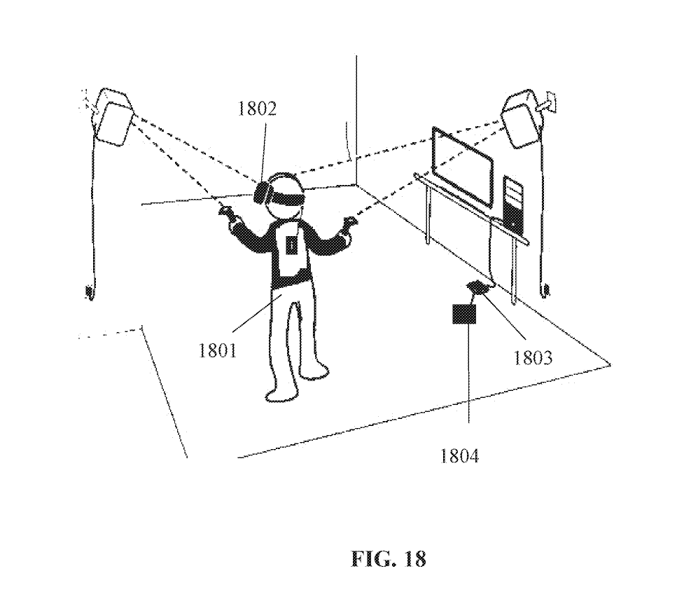

FIG. 17 is a schematic diagram illustrating an exemplary interaction system in prior art. As illustrated in FIG. 17, a user 1701 may wear a HMD 1702 on his or her head, the HMD 1702 may communicate with a processing engine (or host, signal source) 1703 through a cable 1704. FIG. 18 is a schematic diagram illustrating an exemplary interaction system according to some embodiments of the present disclosure. As shown in FIG. 18, a user 1801 may wear a HMD 1802 on his or her head, the HMD 1802 may communicate with a processing engine (or host, or source if signal) 1803 through a wireless communication device 1804. As compared to the prior art illustrated in FIG. 17, the use of the HMD 1802 in FIG. 18 is more convenient, and it can avoid a risk of the user being stumbled over the wires. The present disclosure may include a HMD-end wireless component and a host-end wireless component. The HMD-end wireless component and the host-end wireless component may separately include an antenna and a data processing and controlling unit. The HMD-end wireless component may be connected to a HMD. The host-end wireless component may be connected to a signal resource. The HMD 1820 and the host or the signal resource 1803 may communicate wirelessly.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, in the present disclosure, the term “a plurality of” may refer two or more, unless the context clearly indicates otherwise. The terms “install,” “link,” “connect,” and “fix” used herein in should be broadly understood. For example, the term “connect” may refer to a fixed connection, a detachable connection, an integral connection. As another example, the term “link” may refer to a direct link or a link by an intermediate media. For those skilled in the art, they can understand the meanings of the terms in the present disclosure based on a specific condition.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, radio frequency (RF), or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2103, Perl, COBOL 2102, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to surface modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A display device, comprising:
at least one storage medium including a set of instructions; and
at least one processor implementing an application with a virtual character and at least one of a second application or an operating system, the virtual character being configured to communicate with the at least one of the application, the second application, or the operating system, the at least one processor being configured to communicate with the at least one storage medium, wherein when executing the set of instructions, the display device is configured to:
receive intention data indicative of an intention operation of a user; and execute the virtual character application to:
execute the at least one of the second application or the operating system to perform the intention operation of the user based on the intention data; and
display the virtual character on the display device, wherein a characteristic of the virtual character is related to the intention operation of the user, and wherein the display device comprises a head-mounted display (HMD) device.

2-19. (canceled)

20. A method implemented on a display device for displaying an image, comprising:
receiving, by a processor implementing an application with a virtual character intention data indicative of an intention operation of a user, wherein the virtual character is configured to communicate with at least one of the application, a second application, or an operating system; and
executing the virtual character application to:
execute the at least one of a second application or an operating system to perform the intention operation of the user based on the intention data; and
display the virtual character on the display device, wherein a characteristic of the virtual character is related to the intention operation of the user.

21. The method of claim 20, further comprising:
receiving user information related to the user; and
generating the intention data at least based on the user information.

22. The method of claim 20, further comprising:
providing, through the virtual character on the display device, an execution result of the execution of the intention operation of the user.

23. The method of claim 20, wherein the characteristic of the virtual character comprises at least one of an action of the virtual character, an operation of the virtual character, an expression of the virtual character, a voice of the virtual character, or an image of the virtual character.

24. The method of claim 20, wherein the executing the application comprises:
determining whether a trigger condition is satisfied; and
executing the application in response to a determination that a trigger condition is satisfied.

25. The method of claim 20, wherein the executing the application comprises:
determining whether an interactive operation is performed by a user; and
executing the application in response to a determination that the interactive operation is performed by the user.

26. The method of claim 21, further comprising:
receiving historical operation data of the user.

27. The method of claim 26, wherein the generating the intention data at least based on the user information comprises:
generating the intention data based on the user information and the historical operation data of the user.

28. The method of claim 26, further comprising:
receiving a first set of recommendation data; and
selecting a second set of recommendation data from the first set of recommendation data based on the historical operation data of the user.

29. The method of claim 28, wherein the generating the intention data at least based on the user information comprises:
generating the intention data based on the user information and the second set of recommendation data.

30. (canceled)

31. The method of claim 21, wherein the user information comprises an expression of the user, an action of the user, a voice of the user, and information input by the user, and the generating the intention data at least based on the user information comprises:
generating the intention data by analyzing the expression of the user, the action of the user, the voice of the user, and the information input by the user.

32. The method of claim 21, wherein the user information comprises an expression of the user.

33. The method of claim 32, wherein the receiving user information related to the user comprises:
receiving, by at least one sensor implemented on the display device, a facial image of the user; and
processing the facial image of the user to determine the expression of the user.

34. A non-transitory computer-readable medium storing instructions that, when executed by at least one processor of a system, cause the system to:
receive intention data indicative of an intention operation of a user; and
execute an application with a virtual character implemented on the at least one processor to:
execute at least one of a second application or an operating system to perform the intention operation of the user based on the intention data, wherein the at least one of the application, the second application, or the operating system is configured to communicate with the virtual character; and
display the virtual character on a display device of the system, wherein a characteristic of the virtual character is related to the intention operation of the user.

35-36. (canceled)

37. The non-transitory computer-readable medium of claim 34, wherein the instructions further cause the system to:
receive user information related to the user; and
generate the intention data at least based on the user information.

38. The non-transitory computer-readable medium of claim 34, wherein the instructions further cause the system to:
provide, through the virtual character on the display device, an execution result of the execution of the intention operation of the user.

39. The non-transitory computer-readable medium of claim 34, wherein to execute the application, the instructions further cause the system to:
determine whether a trigger condition is satisfied; and
execute the application in response to a determination that a trigger condition is satisfied.

40. The method of claim 20, wherein the intention data is received from at least one of a mouse, a keyboard, a handle, a remote controller, a button, a touchpad, an image sensor, an audio sensor, a location sensor, a humidity sensor, a biometric sensor, or an ambient light sensor.

41. The method of claim 20, wherein the intention operation includes at least one of a file operation, a program operation, a searching operation, a media operation, a contact operation, a message operation, a recording operation, setting the operating system, controlling the operating system, providing a service, providing a product, chatting with the user, an action interaction, or an expression interaction.
